(19) United States
(12) Patent Application Publication
(10) Pub. No.: US 2025/0208303 A1
(43) Pub. Date: Jun. 26, 2025

(54) COARSE GEOLOCATION OF REMOTE TERMINALS

(71) Applicant: MYRIOTA PTY LTD, Adelaide (AU)

(72) Inventors: Kelvin Jon LAYTON, Adelaide (AU); Alexander James GRANT, Adelaide (AU)

(21) Appl. No.: 18/846,411

(22) PCT Filed: Mar. 14, 2023
(86) PCT No.: PCT/AU2023/050178

§ 371 Date: Sep. 12, 2024

(30) Foreign Application Priority Data
Mar. 14, 2022 (AU) 2022900611

(51) Int. Cl. G01S 19/48; G01S 19/27; G01S 19/28

(52) U.S. Cl. CPC G01S 19/48; G01S 19/27; G01S 19/28

(57) ABSTRACT

A method for coarse estimation (approx. 100 km accuracy) of a location of a terminal in a satellite communication system is disclosed. A terminal may use multiple transmissions from one or more LEO satellites and may estimate a footprint for each transmission using the transmission time and satellite ephemeris. A coarse location may then be determined by estimating an intersection region of each of the estimated footprints. The location may be determined in various ways such as using a centroid, median and optimization methods using error functions. The intersection region may also be approximated as a polygon and may be implemented using a circular buffer to maintain an up-to-date estimate. The method may be performed remotely by a satellite or core network to estimate the location of a transmitter, including non-system transmitters, and may be used as an initial input for more computationally complex signal aided location estimation.

### PRIORITY DOCUMENTS

The present application claims priority from Australian Provisional Patent Application No. 2022900611 titled “COARSE GEOLOCATION OF REMOTE TERMINALS,” filed on 14 Mar. 2022, and is a US National Stage Application of PCT/AU2023/050178, filed on Mar. 14, 2023, the contents of which are hereby incorporated by reference in their entirety.

### BACKGROUND

### Technical Field

The present disclosure relates to estimation of the location of a ground-based terminal in a satellite communications system. In a particular form the present disclosure relates systems in which estimation is either performed at the terminal, or remote from the terminal.

### Description of the Related Art

This application is directed to satellite communications system that is comprised of ground-based transceivers, referred to as terminals, transmitting data using radio signals to one or more low-earth-orbiting (LEO) satellites. These satellites transmit signals to relay the terminals' radio signals to gateways such as ground stations where the received signals are delivered to the core network and end users (e.g., those monitoring their remote assets). These LEO satellites also transmit data using radio signals to the ground-based transceivers. The data transmitted from the satellites to the terminals may be data relayed from the core network and end users, or it may be network information transmitted for the purposes of network control, configuration and optimization. The terminals may be terminals associated with a remote asset or sensor on which the terminal is mounted or has a local connection to, to provide remote Internet of Things (IoT) connectivity such as for monitoring or control of such remote assets and sensors. These remote assets may be fixed or moving (typically at rate much slower than the satellite) such as livestock, personnel, vehicles, industrial machinery, shipping containers, and environmental sensors. Such a system can be used for monitoring large numbers of remotely located assets and sensors (via the associated terminals) operated by a large number of users.

There are several instances where it is useful for the terminal to know the terminal's location (e.g., latitude, longitude) or position. For example, a terminal may wish to determine its location in order to optimize the timing of its transmissions to reduce energy use or to increase performance. For example, a terminal may wish to schedule wake up times for transmission to orbiting LEO satellites based on knowledge of the LEO satellites ephemeris and its location. Even very rough estimates with accuracy of the order of 100 km can be useful, since the size of a typical satellite footprint (the area of the earth that can be seen from the satellite) is thousands of kilometers. Coarse estimates can also serve usefully as initial estimates for more refined location estimation methods.

In other instances, it is not the terminal or a transmitter that needs to know its own location, rather it is an end user or the core network that is interested in knowing the location of the remote terminal or transmitter (or a sensor or asset associated with the remote terminal). This is the case in many IoT tracking applications, or in the case of third-party, or interfering transmitter (i.e., that is not part of the IoT communication system).

In such systems it is often desirable to keep terminal cost, complexity, and power requirements as low as possible to allow widespread and extended use (e.g., potentially for many months to several years). Whilst terminals 10 can be fitted with global navigation satellite system (GNSS) receivers such as GPS receivers which can be used to transmit their location to the Ground station 30 (via LEO satellite 20), adding a GNSS/GPS receiver module adds to both the costs and power requirements. GNSS modules require significant computational resources to estimate location, and additionally the GNSS module must have up-to-date satellite ephemeris data of the GNSS satellites. This typically requires the GNSS module to periodically wake up and acquire the latest almanac every few hours. For example, GPS ephemeris are updated every 4 hours, and in cold start mode it takes a GPS receiver 12 minutes to download the full almanac placing significant burden on power requirements for the terminal. Measurements of remote IoT terminals fitted with GNSS modules in typical uses cases indicate that GNSS operation accounts for almost 50% of energy use. This can seriously impact the battery life (and thus working life) of a remote terminal which may be left unattended for months or years.

Assisted GPS systems can be used to reduce the computational burden or power requirements on the terminals by transmitting recent almanac information to terminals, and/or by allowing terminals to sample the GPS signal and to transmit the samples to a more capable processing device. However, this requires the terminal to be capable of establishing a communication link with sufficient capabilities to send the samples over a communications channel between the terminal and the more capable processing device. In applications with remote terminals 10 for IoT applications as discussed above, this requirement can add significant cost and power requirements to terminals 10.

There is thus a need to provide a system and method for estimation of the location of remote ground-based terminals in a satellite communications system, or other transmitters that avoids the requirement of a GNSS module in the terminal, or at least to provide a useful alternative to existing systems and methods.

### INCORPORATION BY REFERENCE

The following patent applications are referred to in the present application:

PCT/AU2013/000895 titled CHANNEL ALLOCATION IN A COMMUNICATION SYSTEM and filed on 14 Aug. 2013 claiming priority from Australian Provisional Patent Application No. 2012903489 filed on 14 Aug. 2012;

PCT/AU2013/001078 titled COMMUNICATION SYSTEM AND METHOD and filed on 20 Sep. 2013 claiming priority from Australian Provisional Patent Application No. 2012904130 filed on 21 Sep. 2012;

PCT/AU2013/001079 titled MULTI-ACCESS COMMUNICATION SYSTEM and filed on 20 Sep. 2013 claiming priority from Australian Provisional Patent Application No. 2012904145 filed on 21 Sep. 2012;

PCT/AU2014/000826 titled A MULTIUSER COMMUNICATIONS SYSTEM and filed on 21 Aug. 2014 claiming priority from Australian Provisional Patent Application No. 2013903163 filed on 21 Aug. 2013;

PCT/AU2015/000743 titled MULTICARRIER COMMUNICATIONS SYSTEM and filed on Sep. 12, 2015 claiming priority from Australian Provisional Patent Application No. 2014904976 filed on Sep. 12, 2014;

PCT/AU2017/000058 titled TERMINAL SCHEDULING METHOD IN SATELLITE COMMUNICATION SYSTEM and filed on 24 Feb. 2017 claiming priority from Australian Provisional Patent Application No. 2016900685 filed on 25 Feb. 2016;

PCT/AU2017/000108 titled POSITION ESTIMATION IN A LOW EARTH ORBIT SATELLITE COMMUNICATIONS SYSTEM and filed on 16 May 2017 claiming priority from Australian Provisional Patent Application No. 2016901913 filed on 20 May 2016;

PCT/AU2017/000286 titled SYSTEM AND METHOD FOR GENERATING EXTENDED SATELLITE EPHEMERIS DATA and filed on Dec. 21, 2017 claiming priority from Australian Provisional Patent Application No. 2016905314 filed on Dec. 22, 2016; and PCT/AU2018/000151 titled SYSTEM AND METHOD FOR PREDICTION OF COMMUNICATIONS LINK QUALITY and filed on 28 Aug. 2018 claiming priority from Australian Provisional Patent Application No. 2017903470 filed on 28 Aug. 2017.

The content of each of these applications is hereby incorporated by reference in their entirety.

### BRIEF SUMMARY

According to a first aspect, there is provided a method for estimating a location of a terminal in a satellite communication system comprising a plurality of LEO satellites and a plurality of terminals, the method comprising:
receiving a plurality of transmissions from each of one or more LEO satellites;
obtaining an estimate of a current time and ephemeris of each of the one or more LEO satellites;
estimating at least one footprint for each of the plurality LEO satellites from the plurality of transmissions; and
determining a location of the terminal by estimating an intersection region of each of the estimated footprints.

In some embodiments, the method further comprises estimating a location within the intersection region.

In some embodiments, estimating a location comprises estimating a centroid location of the intersection region or the geometric median of the intersection region.

In some embodiments, a footprint of a LEO satellite is estimated as a convex region. In further embodiments this convex region may be obtained by estimating the set of points on a reference surface that have a direct line of sight above a predefined threshold elevation to the LEO satellite.

In some embodiments, determining a location of the terminal by estimating an intersection region of each of the estimated footprints comprises:
defining an error function which is a measure of the error between an estimate of the location obtained from an estimate footprint and an estimate of a true location; and
using an optimization method to optimize the error function to obtain an optimized estimate of the true location of the terminal.

In some embodiments, the intersection region is approximated as a polygon.

In some embodiments, determining a location comprises determining a centroid of the polygon.

In some embodiments, the method further comprises storing the vertices of the polygon, and updating estimates of the vertices of the polygon with each new received transmission from one of the one or more LEO satellites.

In some embodiments, the method further comprises updating an estimate of the polygon comprising receiving a new transmission from one of the one or more LEO satellites; estimating a footprint of the new transmission; and calculating the intersection of the new footprint with each line segment defining the polygon and discarding any vertices in an expanded set that lie outside the new footprint.

In some embodiments, the method further comprises storing a circular buffer of the n footprints of the n previously received transmission, and updating an estimate of the polygon each time a new transmission from one of the one or more LEO satellites using the footprints stored in the circular buffer.

In some embodiments, the method further comprises, obtaining an estimate of at least the Doppler frequency for each of the received transmissions and refining the estimate of location of the terminal using a using a non-linear optimization algorithm configured to use the location of the terminal obtained by the method of any one of claims 1 to 10 as an initial location and to refine the location by minimizing an error function based on at least the estimated Doppler frequencies. In further embodiments the non-linear optimization algorithm is further configured to use a cost function based on the error function at each location obtained using at least the estimated Doppler frequencies.

According to a second aspect, there is provided a method for estimating a location of a transmitter in a satellite communication system comprising a plurality of LEO satellites, the method comprising:
receiving, by one or more LEO satellites, a plurality of transmissions from a transmitter;
obtaining an estimate of a transmission time of each transmission and an ephemeris of each of the plurality of LEO satellites at the transmission time;
estimating at least one footprint for each of the plurality LEO satellites from the plurality of transmissions; and
determining, at a location remote from the transmitter, a location of the transmitter by estimating an intersection region of each of the estimated footprints.

In some embodiments, the method further comprises estimating a location within the intersection region.

In some embodiments, estimating a location comprises estimating a centroid location of the intersection region or the geometric median of the intersection region.

In some embodiments, a footprint of a LEO satellite is estimated as a convex region. In further embodiments this convex region may be obtained by estimating the set of points on a reference surface that have a direct line of sight above a predefined threshold elevation to the LEO satellite.

In some embodiments, determining a location of the transmitter by estimating an intersection region of each of the estimated footprints comprises:
defining an error function which is a measure of the error between an estimate of the location obtained from an estimate footprint and an estimate of a true location; and
using an optimization method to optimize the error function to obtain an optimized estimate of the true location of the transmitter.

In some embodiments, the intersection region is approximated as a polygon.

In some embodiments, determining a location comprises determining a centroid of the polygon.

In some embodiments, the method further comprises storing the vertices of the polygon, and updating estimates of the vertices of the polygon with each new received transmission from one of the one or more LEO satellites.

In some embodiments, the method further comprises updating an estimate of the polygon comprising receiving a new transmission from one of the one or more LEO satellites; estimating a footprint of the new transmission; and calculating the intersection of the new footprint with each line segment defining the polygon and discarding any vertices in an expanded set that lie outside the new footprint.

In some embodiments, the method further comprises storing a circular buffer of the n footprints of the n previously received transmission, and updating an estimate of the polygon each time a new transmission from one of the one or more LEO satellites using the footprints stored in the circular buffer.

In some embodiments, the method further comprises identifying a transmitter by determining one or more signal characteristics of a received transmission, and determining if the signal characteristics match the signal characteristics of a previously received transmission from the transmitter, and if there is a match then using the received transmission to update the estimation of the location of the transmitter.

In some embodiments, the transmitter is a terminal and the method further comprises, obtaining an estimate of at least the Doppler frequency for each of the received transmissions and refining the estimate of location of the terminal using a using a non-linear optimization algorithm configured to use the location of the terminal obtained by the method of the first aspect (when provided to the satellite or core network) or the second aspect as an initial location and to refine the location by minimizing an error function based on at least the estimated Doppler frequencies. In further embodiments the non-linear optimization algorithm is further configured to use a cost function based on the error function at each location obtained using at least the estimated Doppler frequencies.

According to a third aspect, there is provided a terminal for use in a satellite communication system comprising a plurality of LEO satellites, the method comprising:
a receiver for receiving one or more transmissions from one or more of the pluralities of LEO satellites; and
at least one processor and at least one memory, wherein the memory is configured to store ephemeris data for the plurality of LEO satellites, and instructions for configuring the at least one processor to perform the method of the first aspect.

According to a fourth aspect, there is provided a computing apparatus in a LEO satellite or network entity of a satellite communication system comprising a plurality of LEO satellites and a plurality of terminals, the computing apparatus comprising:
at least one processor and at least one memory, wherein the at least one memory is configured to store ephemeris data for the plurality of LEO satellites, and to store instructions to perform the method of the second aspect.

According to a fifth aspect, there is provided a computer-readable medium comprising instructions for configuring one or more processors to perform the method of any of the first or second aspects.

### BRIEF DESCRIPTION OF THE SEVERAL VIEWS OF THE DRAWINGS

Embodiments of the present disclosure will be discussed with reference to the accompanying drawings wherein:

FIG. 1A is a schematic diagram of a low earth orbit satellite communications system according to an embodiment;

FIG. 1B is a schematic diagram illustrating the overlap of low earth orbit satellite footprints according to an embodiment;

FIG. 1C is a schematic diagram of a terminal apparatus according to an embodiment;

FIG. 2A is a flowchart of a method for estimating a location of a terminal in a satellite communication system comprising a plurality of LEO satellites and a plurality of terminals according to an embodiment;

FIG. 2B is a flowchart of a method for estimating a location of a transmitter in a satellite communication system comprising a plurality of LEO satellites according to an embodiment;

FIG. 3A is a schematic diagram illustrating the overlap of low earth orbit satellite footprints according to an embodiment;

FIG. 3B is a plot of the distance error as a function of observation number for a first simulation according to an embodiment;

FIG. 3C is a plot of the distance error as a function of observation number for a second simulation according to an embodiment;

FIG. 4A is a plot of the measured footprint centers for a plurality of transmissions received by a terminal over a 10-day trial period, and the associated polygon intersection region, along with the true (known) terminal location and the estimated mean location according to an embodiment;

FIG. 4B is a histogram plot showing the estimation errors for the mean location (horizontal bars) and median location (vertical bars) for a trial including 540 sets of measurements where the terminal location was known according to an embodiment;

FIG. 4C is a plot of the measured doppler frequencies of the packets received from a terminal at a satellite over a 10-day trial period according to an embodiment; and

FIG. 4D is a heat map cost function for use in a signal aided optimization algorithm according to an embodiment.

In the following description, like reference characters designate like or corresponding parts throughout the figures.

### DETAILED DESCRIPTION

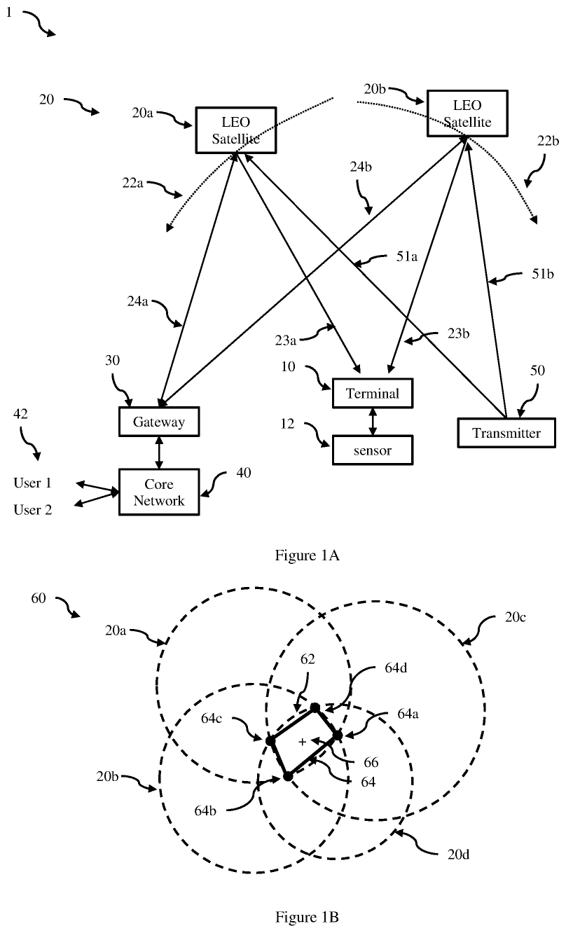

Referring now to FIG. 1, there is shown a schematic diagram of a low earth orbit (LEO) satellite communications system 1 according to an embodiment. The system 1 may be used to provide Internet of Things (IoT) connectivity with remotely located sensors and assets 12 for a plurality of users 42. The satellite communications system 1 is comprised of a plurality of terminals 10, a plurality of low earth orbit (LEO) satellites 20 that act as access nodes for terminals in the system, and a plurality of geographically distributed gateways 30, such as ground stations, which are in communication with core network infrastructure 40. The terminals 10, which may be ground based transceivers, communicate with LEO satellites 20 using radio frequency signals and are connected to, mounted on, or in communication with sensors or assets 12. Similarly, the LEO satellites 20 communicate with the plurality of geographically distributed gateways 30 using radio frequency signals. The core network infrastructure 40 may include cloud-based servers which may manage the system and perform decoding and processing of received signals, and provides an application interface to forward data from the terminals to a plurality of users 42 or otherwise provide an interface to allow users to access data provided by terminals 10. Multiple users may be supported, each communicating with different terminals 10. The satellite communication system may be an embodiment of a satellites communication system described in PCT/AU2013/000895 titled CHANNEL ALLOCATION IN A COMMUNICATION SYSTEM and filed on 14 Aug. 2013, the content of which is hereby incorporated by reference. The satellites, terminals and operation of the communication system may also be as described in PCT/AU2013/001079 titled MULTI-ACCESS COMMUNICATION SYSTEM and filed on 20 Sep. 2013, PCT/AU2014/000826 titled A MULTIUSER COMMUNICATIONS SYSTEM and filed on 21 Aug. 2014 and/or PCT/AU2015/000743 titled MULTICARRIER COMMUNICATIONS SYSTEM and filed on Sep. 12, 2015, the content of each of which is hereby incorporated by reference.

FIG. 1A shows a first LEO satellite 20a travels along an orbital path 22a and transmits signals 23a which are received by terminal 10, and a second LEO satellite 20b travels along an orbital path 22b and transmits signals 23b which are received by terminal 10. The terminal may also transmit signals to the LEO satellites 20a 20b, such as data collected from sensor, for use by a user 42. Also shown is a ground transmitter 50, which is not part of the communication system, and transmits signals 51a 51b which are received by LEO satellites 20a 20b and act as interfering signals. The first and second LEO satellites 20a 20b communicates with gateway 30 via signals 24a 24b. In some locations terminals 10 may be in direct communication with gateway nodes 30, and may receive broadcast signals from gateway nodes 30.

FIG. 1C is a schematic diagram of a terminal apparatus 10 according to an embodiment. The terminal apparatus comprises a communications module 110, with RF front end comprising one or more antennas 112, and associated hardware for preparing data for transmission, including encoding and modulation, and transmitting data to a satellite 20 over a radio frequency uplink and for receiving and decoding data from a satellite 20 (or other sources) over a downlink. The satellite 20 comprises a communications module with RF front end with one or more antennas for communication with terminals and earth stations, a transmitter module and receiver module each of which may comprise encoding/decoding and modulation/demodulation components, a processor and associated memory for storing data (e.g., ephemeris, configuration and performance data), as well as controlling the operation of the satellite and transmission/reception of signals including decoding signals, generating acknowledgments, performing system optimization, and any other supporting operations. In some embodiments the satellites 20 operates in bent pipe mode, or digital sampling with store and forward mode, and performs minimal or no signal processing of received transmissions and redirects received transmissions or packets to a gateway and core network infrastructure for further processing, including remote decoding by cloud-based processors.

The terminal apparatus also comprises a processor module 120 and memory 130. The memory comprises software instructions or software modules to cause the processor to implement the methods described herein. The memory may also be used to satellite ephemeris, satellite footprints, measured and estimated signal parameters, and any data, parameters or metrics used to generate or update such estimates. The memory may comprise one or more databases, circular buffers, or other storage structures. The memory may also be used to store modules for other functions. Other components such as power supply, clock, sensor platform, etc., may also be included in the terminal apparatus. On start-up the terminal may determine a system time or acquire a system time by listening to one or more satellites. The terminal may also listen for ephemeris data or updates broadcast by the system satellites, or load ephemeris data into the memory from a storage device. For example, the ephemeris could be an extended ephemeris stored in the memory and obtained using the method as described in PCT/AU2017/000286 titled SYSTEM AND METHOD FOR GENERATING EXTENDED SATELLITE EPHEMERIS DATA and filed on Dec. 21, 2017, the content of which is hereby incorporated by reference.

During use data may be exchanged with other local devices 12 via a local communications module 140 for example over a short-range wireless connection using Bluetooth or Wi-Fi based protocols, or a wired interface such as a USB interface or direct connection. Additionally, the terminal apparatus may receive timing information via the communications module 110, or the terminal apparatus may include a stable on-board clock which is periodically synchronized with UTC, for example during servicing or maintenance.

The core network infrastructure is in communication with gateway nodes 30 and may include an authentication broker, scheduler and an App Gateway. The broker can exchange data with user applications via App Gateway and control information directly with user applications. The component of the core network infrastructure may be distributed and communicate over communications links. Some components maybe cloud based. Terminals or satellites may provide information to the core network for performing location estimation of terminals or non-system transmitters 50 (e.g., interferers) and providing feedback information for terminals.

In some embodiments, the system 1 uses a publisher subscriber model, and comprises the following system entities:

Terminals 10: A communication module within a terminal provides core network connectivity to access nodes. Terminals 10 may have both devices 102 and sensors 104 attached. These may be physically attached or integrated, or operatively connected to the terminal over a local wired or a local wireless link.

Devices 12: These entities receive data to which they are subscribed via the authentication broker.

Sensors 12: These entities publish data with no awareness of other network nodes. Sensors may also be able receive ephemeral control data, publish ACK messages, etc.

Access Node 20: A plurality of access nodes provides wireless communications with a plurality of terminals. Most access nodes are satellite access nodes, but the system may include terrestrial base stations. Satellite access nodes provide access to the core network 40. Access Gateway 30: These act as gateways between Access Nodes and the Authentication Broker. The gateway may be combined with the Access Node 20 (for example on board a satellite).

Authentication Broker: Broker between Publishers and Subscribers. Brokers authenticate that received messages are from registered terminals.

App Gateway: Data gateway between User Applications and the Broker, implementing a number of interfaces. This may be a cloud-based interface. Interfaces include a Message Queue Telemetry Transport (MQTT) interface, forwarding to a customer-controlled Endpoint; or a customer-accessible Endpoint.

User Applications: These communicate with the App gateway over wired and wireless links, for example to a cloud-based App Gateway.

There are several instances where a terminal may be interested in estimating a coarse location of the terminal (on-board geolocation). For example, if a terminal knows its own location, and ephemeris of orbiting LEO satellites it can optimize the timing of its transmission to reduce energy use, or to increase performance. Even very coarse estimates, of the order of 100 km or more, can be useful in early operations, as they can serve as initial estimates for more refined location estimations methods. For example, optimization based signal aided estimation techniques, such as those discussed in PCT application PCT/AU2017/000108 (WO2017197433) titled POSITION ESTIMATION IN A LOW EARTH ORBIT SATELLITE COMMUNICATIONS SYSTEM and filed on 16 May 2017, the content of which is hereby incorporated by reference.

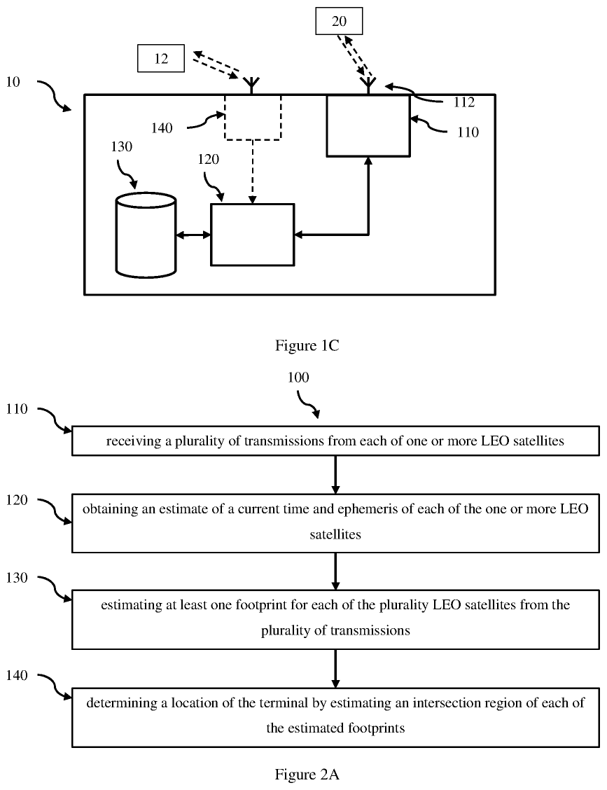

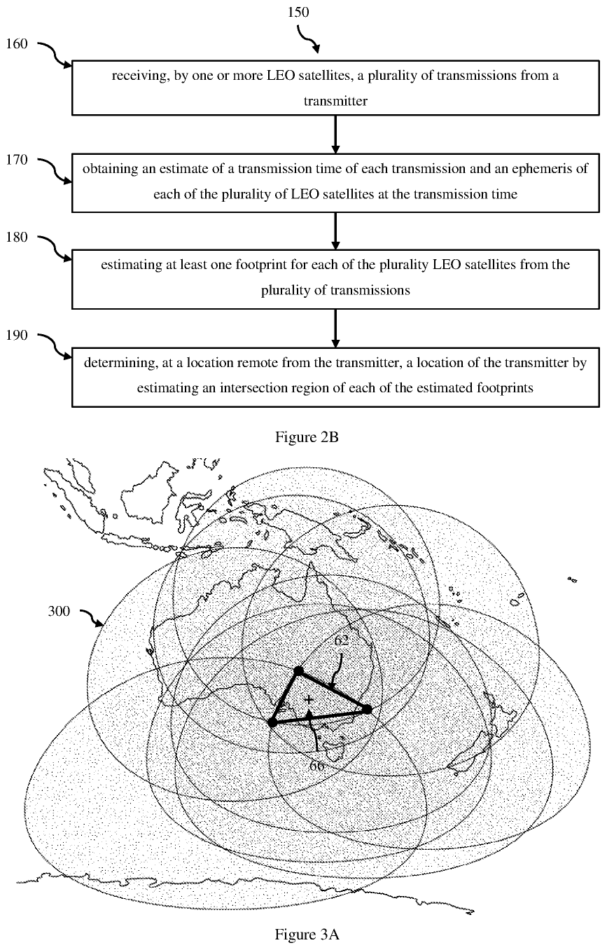

Embodiments of a method for estimating a location of a terminal 10 in a satellite communication system 1 will now be described. The location may also be referred to as a geolocation or position. A flowchart of the method 100 is further illustrated in FIG. 2A. Broadly the method comprises receiving a plurality of transmissions from each of one or more LEO satellites 110. The terminal then obtains an estimate of a current time and ephemeris of each of the one or more LEO satellites 120. The terminal estimates at least one footprint for each of the plurality LEO satellites from the plurality of transmissions 130 and then determines a location of the terminal by estimating an intersection region of each of the estimated footprints 140, i.e., a geolocation. In this embodiment the location is a coarse location defined by the intersection region. In further embodiments the location may be a location within the intersection region as discussed below.

This is further illustrated in FIGS. 1A and 1B. FIG. 1A shows a first LEO satellite 20a travelling along an orbital path 22a and transmits signals 23a which are received by terminal 10. A second LEO satellite 20b travels along an orbital path 22b and also transmits signals 23b which are received by terminal 10. That is the terminal has received several transmission from one or more LEO satellites. The terminal has a clock (or oscillator) such that a reception time can be determined for each received transmission 23a 23b. Further the terminals can identify transmissions from the same satellite, for example by decoding a unique satellite identifier included in each transmission by a satellite, or otherwise determining, for example during decoding or other signal analysis of the transmission, transmission characteristics or parameters that uniquely identify transmissions from the same satellite.

In some embodiments, as satellites move along their orbital path, they periodically broadcast beacon signals including their satellite identifier. These may be broadcast every second, at the start of a frame of fixed duration, or some other fixed time interval as determined by the system 1. Using the satellite identifier, the terminal can lookup (in a memory or on board database) a stored ephemeris of the satellite that transmitted the received transmission. It is noted that a terminal may receive multiple transmissions from the same satellite, each at different times, and a terminal may receive multiple transmissions from multiple satellites over some time period. The terminal may listen continuously for a fixed time period (e.g., 10 seconds), or listen periodically, e.g., listen for 1 second every 60 seconds for 10 minutes (e.g., 10 observations) or for 1 second every 5 minutes over 12 or 24 hours. The length of time to listen for transmissions may be of the order of milliseconds to a few seconds. Spacing out observations (e.g., every 5, 10, 15 or 60 minutes) also increases the opportunity to capture different satellites on different orbital paths. Determination of the listening duration and frequency may be performed based on parameters of the satellite communication system, such as typical pass length (time during which a satellite is overhead for a given point on the earth's surface), and frequency of beacon signals. In some embodiments, LEO satellites have a pass length of approximately 5 minutes.

From the received transmissions, the terminal can estimate a footprint of the satellite for each transmission using the time of the transmission and ephemeris of the respective satellite. The satellite footprint is defined as the set of feasible locations where transmission from the satellite to those locations is possible. This is the region that can “see” the satellite at the time of transmission. In one embodiment these locations are the locations on the surface of the earth, and may be locations on a reference surface such as a geodetic datum including global datums such as WGS 84 or for the terminal to have received the transmissions, the terminal must be, by definition, within the intersection of these footprints. Thus an initial coarse estimate of the location may be the entire intersection region of the footprints.

More preferably the coarse estimate is a point or location within the intersection region. In the absence of any other information, each point in the intersection is equally likely to be the terminal location. This in one embodiment a coarse estimate of the terminal location is the geometric median of this intersection region. This point has the property (by definition) that it minimizes the averaged location error (averaged over all equi-likely points in the region). Similarly the coarse estimate of location could be centroid location of the intersection region, or another central estimator such as a mean or weighted mean. In one embodiment, a center of each footprint could be estimated and used to define the intersection region, such as a polygon that contains all the centers (i.e., most distant centers form the vertices). In one embodiment the coarse estimate is calculated as the mean of all centers. In one embodiment the center of the footprint is estimated by first converting the location of the satellite (from the ephemeris data) into Earth-centered, Earth fixed (ECEF) coordinates for each transmission, and then calculating the mean of these points (centers) to obtain the estimate of the center of the intersection region. Another central estimator such a median or weighted mean may also be used. The weightings could be determined using a metric obtained when decoding the transmission, such as SNR or SINR or doppler.

While in practice, footprints may have irregular shapes due to terrain, and other radio propagation characteristics, as a simplifying assumption, we can define the footprint to be the set of points that has direct line of sight above some threshold elevation (e.g., 5°, 10°, 15° or) 20° to the satellite. These points may be estimated using (or on) a reference surface such as geodetic datum (e.g., WGS 84) and may be estimated using geometric methods (e.g., intersection of a cone with a surface) and/or coordinate transformations. In another example an ellipse, for example in an ECEF, could be selected with the property that each point has a direct line of sight to the satellite at least above the threshold elevation. These regions have the important property that they are convex. Furthermore, set intersection preserves convexity, and thus an intersection of convex footprints defines a convex intersection region. Other numerical, mathematical or geometric methods may also be used to define a convex regions for each satellite. For example the footprint could be estimated on the reference surface, and a convex shape fitted within the boundary. A buffer zone could also be defined (e.g., 10 km, 20 km, 50 km, etc.,) analogous to the elevation threshold approach and the convex shaped fitted within the inner boundary of the buffer zone.

In an example, there are n received transmissions. Let Fᵢ, i=1, 2, . . . , n be the footprint corresponding to transmission i. To estimate the location, an optimization method can be used in which the objective function is an error function d (y) which which is a measure of the error between an estimate of the location (x) obtained from an estimate of a footprint and an estimate of a true location (y). For example, let the error function d (y)=∫_{∩F}_{ᵢ}∥x−y∥ dx where the norm is Euclidean if approximated to a flat space, or length of the geodesic if curvature is accounted for. For a particular choice of y Σ∩Fᵢ, the average error is proportional to d (y), and hence this may be adopted as an objective function for minimization over all feasible y. Note that since norms are convex, d (y) is a convex function. Summarizing, the coarse estimator is:

$$\hat{y} = arg {min}_{y} d ( y ) subject to y ∈ {F}_{1} , y ∈ {F}_{2} , ⋯ , y ∈ {F}_{n} \qquad ( 1 )$$

Since this is optimizing a convex function over a convex set, standard, gradient-based optimization approaches such as Newton's method will converge. The optimal point is by definition the geometric median of ∩Fᵢ. That is solving the optimization problem defined in equation 1 returns an estimate of the location which is the geometric median of the intersection region.

In another example, the error function may be chosen as the squared distance: d (y)=∫_{∩F}_{ᵢ}: ∥x−y∥² dx. The resulting optimization is by definition the centroid of ∩Fᵢ. The centroid is computed as follows:

$$\hat{y} = {( {\int }_{⋂ {F}_{i}} dx )}^{- 1} {\int }_{⋂ {F}_{i}} x dx \qquad ( 2 )$$

The performance of such estimators is ultimately governed by the size of ∩Fᵢ. Thus, estimation is performed using multiple transmissions and the accuracy will increase as more transmissions are received. Typically, the accuracy increases rapidly with the first few transmissions (n<10) and then stabilizes. The rate at which accuracy improves depends upon the number of different satellites observed, and the time interval over which transmissions are obtained. For example, in some embodiments a single satellite could be viewed over the duration of a transit (e.g., 5 mins). In this case the intersection region has a lenticular shape with the estimates at the leading and trailing ends of the transit acting to constrain the intersection region in the direction of motion of the satellite (or transit). Each additional satellite observed acts to significantly constrain size of the intersection region as each satellite will typically have a different (and non-aligned) orbital path. Having two satellites with orthogonal orbital paths acts to tightly constrain the orbital path. Listening to the same satellite over multiple satellite passes can also assist in more tightly constraining the intersection region. Various error functions may be defined, and weighted error functions may be used, for example based on signal strength, number of transmissions or geometry. For example, it may be beneficial to weight observations from more distant or newly detected satellites from which only a few transmissions have been received.

As discussed above, in many embodiments the terminal is a remote terminal located outside of the range of terrestrial communications systems and be required to provide low bandwidth connectivity for a remote asset (e.g., for basic monitoring) for a period of months to several years. Further to enable wide spread use the terminal is often a low cost device with limited processing capability, limited storage and battery life, and it is of interest to formulate easily computable estimates to minimize power consumption in order to maximize battery life.

We can obtain simplifications to either of the above estimators by approximating the feasible region ∩Fᵢ by a polygon, defined by the subset of points of intersection of the footprints that lie in every footprint. The centroid of the polygon can then be used as the estimate of the location.

This is illustrated in FIG. 1B which is a schematic diagram illustrating the overlap 60 of four low earth orbit satellite footprints according to an embodiment. In this example each of the four satellites has an associated footprint 20a, 20b, 20c, 20d (shown as dashed line circles in FIG. 1B). The four footprints define an intersection region 62. A polygon 64, illustrated by thick solid black lines in FIG. 1B, is defined by vertices shown as solid dots 62a 62b 62c 62d which are the points of intersection between two footprints. For example vertex 64a is defined by the intersection of footprints 20a and 20b, vertex 64b is defined by the intersection of footprints 20b and 20c, vertex 64c is defined by the intersection of footprints 20c and 20d, vertex 64d is defined by the intersection of footprints 20b and 20d. The centroid 66 of the polygon 64 is indicated by a “+” in FIG. 1B.

This polygon 62 is an inner bound to the intersection region 62 and the resulting estimators are approximations. This has the advantage that the calculation of the centroid of a polygon has low complexity (i.e., simple).

Consider a non-self-intersecting polygon in two dimensions defined by the set of points (xᵢ, yᵢ), i=1, 2, . . . , n where these points are arranged in counter-clockwise order. The area of the polygon is given by:

$$A = {\sum }_{i = 1}^{n - 1} {x}_{i} {y}_{i + 1} - {x}_{i + 1} {y}_{i} \qquad ( 3 )$$

If the points are instead arranged in clockwise order, this area will be of the same magnitude, but negative. Hence A is called the signed area. The centroid (x̅, y̅) is given by:

$$\overline{x} = \frac{1}{6 A} {\sum }_{i = 1}^{n - 1} ( {x}_{i + 1} + {x}_{i} ) ( {x}_{i} {y}_{i + 1} - {x}_{i} {y}_{i} ) \qquad ( 4 )$$

$$and$$

$$\overline{y} = \frac{1}{6 A} {\sum }_{i = 1}^{n - 1} ( {y}_{i + 1} + {y}_{i} ) ( {x}_{i} {y}_{i + 1} - {x}_{i} {y}_{i} ) \qquad ( 5 )$$

The centroid 66 can thus be quickly and efficiently estimated from the polygon's vertices.

Another advantage of using a polygon 64 to approximate the intersection region 62 is that only the vertices of this polygon need to be stored and updated with each new received transmission. Thus in some embodiments, the vertices are stored by a memory and we update them with each new received transmission from one of the LEO satellites.

The polygon can also be iteratively updated by calculating the intersection of a new footprint with the line segments defining the polygon and discarding any vertices in the expanded set that lie outside the new footprint. That is on receiving a new transmission from one of the LEO satellites we estimate a footprint of the new transmission and calculate the intersection of the new footprint with each line segment defining the polygon. We discard any vertices in an expanded set that lie outside the new footprint.

In further embodiments, just the footprint centers are stored by the memory, and the polygon can be recomputed when required. This approach facilitates time windowing, whereby a circular buffer of only the most recent footprint centers is stored. That is, a circular buffer of the last n footprints (i.e., of the n previously received transmissions) is stored, and an estimate of the polygon is updated each time a new transmission from one of the LEO satellites using the footprints stored in the circular buffer is received. This provides an efficient implementation for maintaining an up-to-date estimate of the terminal location.

In some embodiments terminals may be within range of gateways 30 which broadcast beacons and these transmissions may also be used (along with satellite transmissions). This requires knowledge of the location of the gateway and transmission range (e.g., footprint). The location and transmission range may be stored by the terminal or recovered from the beacon signal (if included).

The coarse estimates produced by the above methods can then be used by the terminal, for example as an initial estimate for use by a more complex location estimator, such as a signal aided estimator as described below.

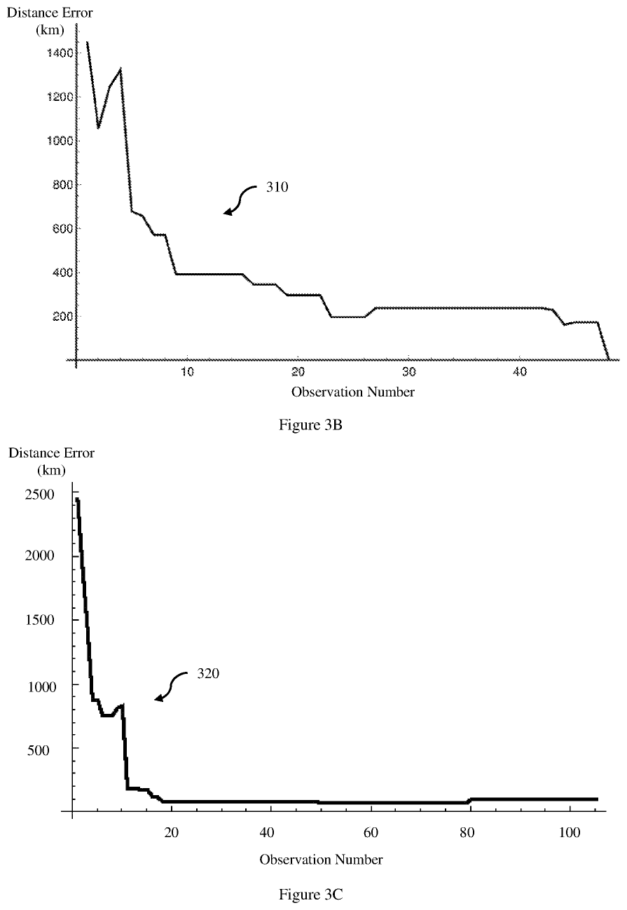

Simulations of the above method were performed using actual orbital parameters of a constellation of 15 LEO satellites. FIG. 3A is a schematic diagram illustrating the overlap 300 of the footprints of 8 low earth orbit satellite captured during one simulation, showing the resultant polygon 62 and estimated centroid 66. Each pass over a location was around 5 minutes. In this embodiment the terminal was placed at a known location and every five minutes an observation was made by the terminal to determine if the terminal was in the footprint of any satellites at that point in time (based on the real orbits). If a satellite was observed, then an updated location of the terminal (centroid of polygon) was estimated using the latest and all previous footprints to that point (i.e., all cumulative observations). The error (difference between actual and estimated centroid location) was then determined for each observation.

FIG. 3B is a plot of the distance error as a function of observation number 310 for a first simulation with the terminal at a first location according to an embodiment. This simulation was performed over a 12 hour period (tracking 15 satellites) and the distance error 310 was initially around 1400 km but dropped to around 400 km after 10 observations and plateaued at around 250 km until dropping to 7 km at the end of the 12 hours. FIG. 3C is a plot of the distance error as a function of observation number 320 for a second simulation with the terminal at a second location according to an embodiment. This simulation was performed over a 24-hour period (again tracking the same 15 satellites) and the distance error 320 was initially around 2500 km but rapidly dropped to around 800 km and then to around 200 km after 10 observations and plateaued at around 70 km until the end of the 24 hours.

These simulations indicate that in the case of LEO satellites accuracies of the order of a few 100 km can be obtained with as few as 10 observations, and that these can be further reduced to less than 100 km with 20 or more transmissions. These simulations also indicate that accuracies of the order of 10 km can be obtained using embodiments of the above method.

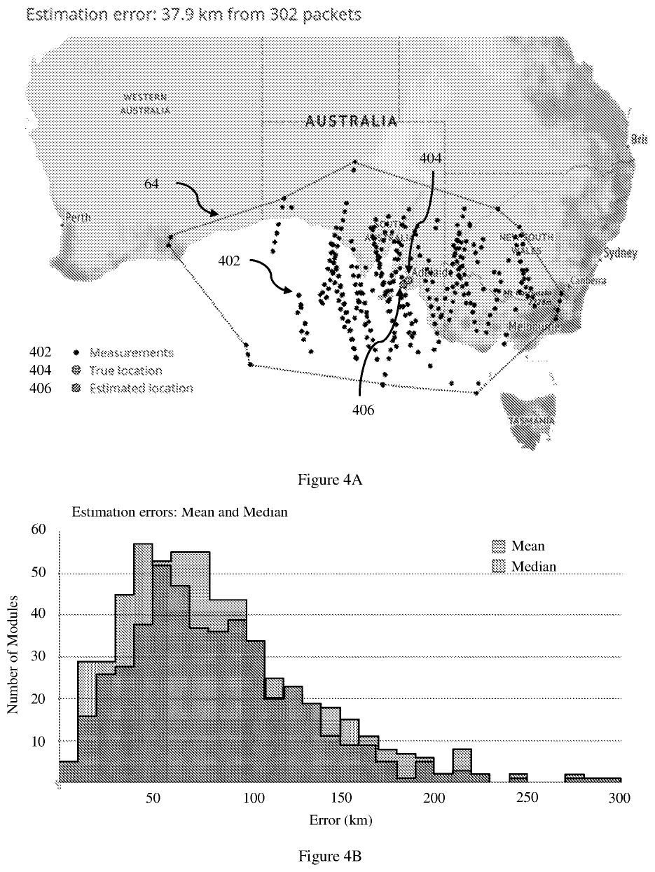

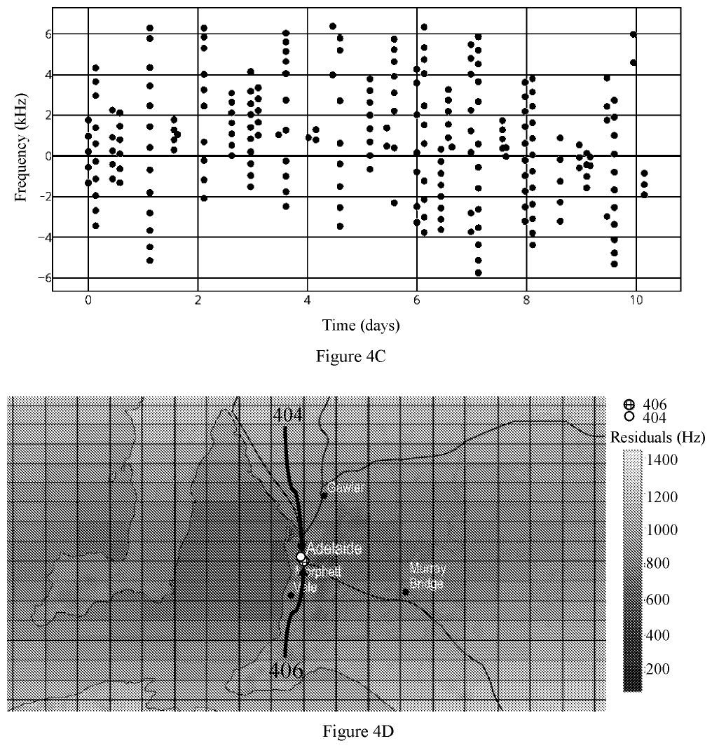

In another example, a 10 day trial was conducted in the Adelaide region of South Australia in which a terminal collected a set of 302 packets from several satellites over a 10 day period. The average pass length of each satellite was approximately 5 minutes and a total of 4 satellites were observed. The footprint centers were estimated by obtaining the satellite location at the time of the transmission from the respective satellite ephemeris and converting to an earth-centered, earth fixed (ECEF) coordinate. The location of the terminal was then estimated by calculating the mean of these footprint centers and compared with the known true location. In this trial the estimation error was 37.9 km. FIG. 4A is a plot of the measured footprint centers 402 for each of the 302 transmissions, the polygon intersection region 64 containing all measurements (footprint centers) 402, along with the true (known) location 404 and the estimated mean location 406. This process was then repeated 540 times to obtain 540 sets of measurements/footprint centers (each defining an intersection region) and for each set estimating the mean of the set and the median of the set, each of which was compared to the known true location to build a histogram of the estimation errors. FIG. 4B is a histogram plot showing the estimation errors for the mean location (horizontal bars) and median location (vertical bars). As can be seen in FIG. 4B, the mean and median gave similar results (see overlapping region), with both typically estimating the location to within 100 km of the true device location, although the median estimator has a slightly improved distribution and accuracy (i.e., left shifted) likely due to reduced influence of outliers.

The method can also be performed in a reverse orientation, for example by a satellite or the core network in order to remotely estimate a location of a transmitter within the field of view of a satellite or multiple satellites. This transmitter may be a terminal in the communication system but need not be system entity and could be a source of potential interference. FIG. 2B is a flowchart of a method 150 for estimating a location of a transmitter by a satellite communication system comprising a plurality of LEO satellites according to an embodiment.

Broadly the method 150 comprises receiving, by one or more LEO satellites, a plurality of transmissions from a transmitter 160. An estimate of a transmission time of each transmission and an ephemeris of each of the plurality of LEO satellites that received the transmission at the transmission time 170 may then be obtained. At least one footprint for each of the plurality LEO satellites from the plurality of transmissions 180 may be estimated and, at a location remote from the transmitter, a location of the transmitter may be determined by estimating an intersection region of each of the estimated footprints 190.

This method may be performed by a single satellite, if it receives multiple transmissions from the transmitter, or by a satellite if it receives a message from other satellites in the network that they received the same transmission (at the same time) provided it has knowledge of the other satellites ephemeris. Alternatively the satellites that receive the transmission can transmit the time of the transmission to a gateway, and a computing apparatus in the core network infrastructure can perform the estimation of the transmitter location. The above described variations including use of convex intersection regions, polygons and optimization as discussed above may also be used with this method.

In some embodiments, the transmitter includes a unique identifier in the transmissions facilitating identification of transmissions from the same transmitter. However, in some embodiments, the satellites (or core network infrastructure) may not be able to decode the identifier or no identifier may be present. In these cases the method may further comprise identifying a transmitter by determining one or more signal characteristics of a received transmission, and determining if the signal characteristics match the signal characteristics of a previously received transmission from the transmitter. If there is a match then the received transmission may be used to update the estimation of the location of the transmitter. The signal characteristics may be obtained signal analysis on the received signals, or from attempted decoding of the received signal.

The coarse estimates produced by the above methods can also be used as an initial estimate for use by a more computationally complex location estimator, such as a signal aided estimator described in PCT/AU2017/000108 titled POSITION ESTIMATION IN A LOW EARTH ORBIT SATELLITE COMMUNICATIONS SYSTEM and filed on 16 May 2017, the content of which is hereby incorporated by reference. As the satellites pass over the terminal the doppler shift, and related parameters such as time offset and rate of change of Doppler frequency, will change as they depend upon the location of the terminal (relative to the satellite). This is illustrated in FIG. 4C, which shows a plot of the measured doppler frequencies of the packets received from the terminal at the satellite over the 10 days of the earlier referred to trial. The coarse location estimate was then refined using an optimization algorithm to find the location of the terminal x̅ₜ that best fits the observed doppler shift measurements using the coarse location as a starting point. ω_{c} is defined as the center frequency of the transmission, and a frequency estimate ω₀ⱼ is obtained with respect to ω_{c} with respect to the precise time tⱼ of the transmission of packet j. The estimate of the terminal position is defined as xₜ and the time varying distance between the terminal and the satellite position Xₛ(t) is further defined at time t, to be d(t|xₜ)=∥xₜ−xₛ(t)∥₂. The time varying doppler frequency is similarly defined as ω(t|xₜ) and error function is defined as Δω₀ⱼ (xₜ)=ω(tⱼ|xₜ)−ω₀ⱼ. The total error is defined as Δ(xₜ)=Σⱼ₌₀^{j-1}αₒⱼ∥Δω₀ⱼ (xₜ)∥² where here α₀ⱼ is a non-negative constant which are used to weight the contributions to the total error function. These may be estimated based on decoding metrics or other system parameters, otherwise they may be set to one (1) if no weights are used (default case). Similar equations may be defined for time offset and/or doppler frequency rate of change parameters, and similar error functions can be added to the total error to improve the estimate. The signal aided position estimator is then configured to produce a refined estimate x̅ₜ of the terminal position by solving the non-linear optimization problem

$${x}_{t} = {arg min}_{{x}_{t} ∈ 𝒳} Δ ( {x}_{t} ) .$$

This optimization problem may be solved by a nonlinear least squares algorithm (or other suitable algorithm) to obtain the refined estimates. In some embodiments, optimization is performed using a trust region reflective algorithm along with a cost function estimated using residuals. FIG. 4D is a plot of an example heat map cost function estimated using residuals. Each square in the map was computed using an estimate of the error function Δ(x) for each location (grid cell in the heat map) which was obtained using the measured doppler ω₀ⱼ such that locations closer to the true location have reduced “cost”. The optimization algorithm then searches for the location that minimize this function resulting in a final location estimate.

Estimation of the doppler frequency may be further assisted by using beacon signals or received packets. The beacon signals could be other terminals and/or non-system transmitters including non-system satellites which transmit beacons or known signals to announce their presence. By measuring the frequency offset of the beacon signals, an improved estimate of the channel effect can be obtained, which in turn, enables an improved estimate of the doppler frequency to be obtained which is then used in the optimization algorithm.

Table 1 below presents the results from a further 4 day trial in which four devices were spread over two locations with two devices per location. The two locations were in the Adelaide region, separated by 17 km such that they observed the same set of four satellites over the 4 days. A set of packets was received from each terminal and then used to estimate a coarse location. Additionally, the doppler shift was also measured at the satellite as described above and the optimization method used to refine the position estimate. Table 1 lists the total number of packets received from each terminal, along with the accuracy obtained using the footprint based method to estimate the coarse location, and the accuracy using the doppler based method which refined the coarse estimate.

TABLE 1
Results from a 4 day trial for coarse and
refined estimate of a terminal location.

| | Number of Packets | Error | | Error |
|---|---|---|---|---|
| Module | received | (Footprint based) | | (Doppler based) |
| 1 | 374 | 55.9 | km | 2.3 km |
| 2 | 246 | 61.1 | km | 4.5 km |
| 3 | 238 | 131.4 | km | 7.1 km |
| 4 | 234 | 53.6 | km | 5.5 km |

As can be seen in Table 1, most coarse estimates were well under 100 km, and these location estimates were further significantly refined using a Doppler based method to update refined estimates with errors of the order of 5 km.

In the above described embodiments, the refined estimation is performed remotely from the terminal such by the satellite or by the core network, both of which are less power constrained than terminals. However it is to be understood that the method could also be performed by the terminal using packets received from one or more satellites. In these embodiments, the doppler measurements (or time delay and/or rate of change of doppler) are measured by the terminal and may be obtained from decoding packets received from satellites or by processing received signals. Doppler measurements may also be obtained from beacon satellites or other beacon transmitters. As this signal aided estimation method is more computationally intensive, use of this embodiment may be reserved, and only performed on demand for specific requirements or applications where higher accuracy is required. The terminal may be configured to use, by default, coarse estimates of location for tasks such as scheduling and reserve the more power intensive signal aided estimation for specific higher priority use (e.g., only used on demand). For example the terminal may be configured to provide communication services for a co-located sensor, for example to report sensor measurements or status back to the core network (e.g., for use by the sensor owner). In the case of a sensor error condition or specific use case, an accurate estimation of location may be required, and thus the control software for the sensor may request an accurate estimation of location from the terminal, which could then be used by the sensor and/or included in a transmission by the terminal. A hybrid approach could be performed in which coarse estimation is performed by the terminal, which transmits this to the satellite and/or core network, which then uses this as an input position to the signal aided estimation method performed by the satellite or core network.

Embodiments of the methods described above (and systems implementing these methods) provide improved methods for coarse estimation of the locations of remote ground-based terminals in a LEO satellite communications system that that avoids the requirement of a power hungry GNSS module in the terminal. Embodiments of the methods described herein define an intersection region of foot prints from multiple transmissions. The use of an elevation threshold can be used to ensure convexity, which further enables use of optimizing techniques. Notably as the regions are convex the geometric median is the optimal location within the intersection region. Convexity also enables a centroid to be estimated using optimization on error functions including weighted error functions to further improve the estimation. Efficient implementation can be achieved by approximating the intersection region as a polygon, which has the advantage that calculation of a centroid is low complexity. Further, a circular buffer may be used to maintain an up-to-date estimate of the terminal location.

Embodiments can thus be advantageously implemented in low-cost terminals with limited processing capability, limited storage and battery life (and without a GNNS module) and provide significant power savings. Terminals can use the coarse estimates of the terminal's location to enable a terminal to optimize the timing (scheduling) of its transmission to reduce energy use, or to otherwise increase performance, such as by scheduling transmissions to improve the probability of a success transmission. Embodiments have low computational complexity and low storage requirements and thus can be efficiently computed by a terminal thus minimizing power consumption. In particular, they may be used by remotely located low-cost terminals with limited processing capability, limited storage and battery life, which may be left unattended for many months or several years, and for which lower power consumption is of critical importance.

Additionally, embodiments of the method may also be performed remotely from the terminal by a satellite or by the core network, and may also be used to estimate the location of a transmitter such as non-system transmitter which acts as a source of interference. In the remote case, the coarse estimates can serve as initial estimates for more computationally complex (and power intensive) optimization based signal aided estimation techniques which provide more accurate or refined location estimations (e.g., 5 km vs 100 kms). These may use estimates of doppler frequency and related parameters which vary based on terminal location. These signal aided estimation methods as described above, which use the coarse estimate as an initial location, can also be implemented by a terminal when a more accurate estimation of location is required. This provides a remote terminal with flexibility in controlling power consumption. The terminal may be configured to use, by default, coarse estimates of location for tasks such as scheduling and reserve the more power intensive signal aided estimation for specific higher priority use (e.g., only used on demand).

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software or instructions, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or other electronic units designed to perform the functions described herein, or a combination thereof.

In some embodiments the processor module comprises one or more Central Processing Units (CPUs) configured to perform some of the steps of the methods. The computing apparatus may also comprise one or more graphical processing unit (GPUs), Tensor processing units (TPUs), input devices and output devices. A CPU may comprise an Input/Output Interface, an Arithmetic and Logic Unit (ALU) and a Control Unit and Program Counter element which is in communication with input and output devices through the Input/Output Interface. The Input/Output Interface may comprise a network interface and/or communications module for communicating with an equivalent communications module in another device using a predefined communications protocol (e.g., Bluetooth, Zigbee, IEEE 802.15, IEEE 802.11, TCP/IP, UDP, etc.). The computing or terminal apparatus may comprise a single CPU (core) or multiple CPU's (multiple core), or multiple processors, as well as GPUs and TPUs. The computing or terminal apparatus may use a parallel processor, a vector processor, or be a distributed computing device, including cloud based computing devices and resources. Memory is operatively coupled to the processor(s) and may comprise RAM and ROM components, and may be provided within or external to the device or processor module. The memory may be used to store an operating system and additional software modules or instructions. The processor(s) may be configured to load and executed the software modules or instructions stored in the memory.

Software modules, also known as computer programs, computer codes, or instructions, may contain a number a number of source code or object code segments or instructions, and may reside in any computer readable medium such as a RAM memory, flash memory, ROM memory, EPROM memory, registers, hard disk, a removable disk, a CD-ROM, a DVD-ROM, a Blu-ray disc, or any other form of computer readable medium. In some aspects the computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media. In another aspect, the computer readable medium may be integral to the processor. The processor and the computer readable medium may reside in an ASIC or related device. The software codes may be stored in a memory unit and the processor may be configured to execute them. The memory unit may be implemented within the processor or external to the processor, in which case it can be communicatively coupled to the processor via various means as is known in the art. A computer program may be written, for example, in a general-purpose programming language (e.g., Python, Java, C++, C, C#, etc.) or some specialized application-specific language, and may utilize or call software libraries or packages for example to implement data interfaces (e.g., JSON) or utilize machine learning (e.g., TensorFlow, CUDA) or numerical optimization.

Further, it should be appreciated that modules and/or other appropriate means for performing the methods and techniques described herein can be downloaded and/or otherwise obtained by the computing device. For example, such a device can be coupled to a server to facilitate the transfer of means for performing the methods described herein. Alternatively, various methods described herein can be provided via storage means (e.g., flash disk, RAM, ROM, a physical storage medium such as a compact disc (CD) or floppy disk, etc.), such that a computing device can obtain the various methods upon coupling or providing the storage means to the device. Moreover, any other suitable technique for providing the methods and techniques described herein to a device can be utilized.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, the terms “estimating” or “determining” encompasses a wide variety of actions. For example, “estimating” or “determining” may include calculating, computing, processing, deriving, investigating, looking up (e.g., looking up in a table, a database or another data structure), ascertaining and the like. Also, “estimating” or “determining” may include receiving (e.g., receiving information), accessing (e.g., accessing data in a memory) and the like. Also, “determining” may include resolving, selecting, choosing, establishing and the like.

The reference to any prior art in this specification is not, and should not be taken as, an acknowledgement or any form of suggestion that such prior art forms part of the common general knowledge.

It will be understood that the terms “comprise” and “include” and any of their derivatives (e.g., comprises, comprising, includes, including) as used in this specification, and the claims that follow, is to be taken to be inclusive of features to which the term refers, and is not meant to exclude the presence of any additional features unless otherwise stated or implied.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for estimating a location of a terminal in a satellite communication system comprising a plurality of LEO satellites and a plurality of terminals, the method comprising:
receiving a plurality of transmissions from each of one or more LEO satellites;
obtaining an estimate of a current time and ephemeris of each of the one or more LEO satellites;
estimating at least one footprint for each of the plurality LEO satellites from the plurality of transmissions; and
determining a location of the terminal by estimating an intersection region of each of the estimated footprints.

2. The method as claimed in claim 1, further comprising estimating the location within the intersection region, wherein estimating the location comprises estimating a centroid location of the intersection region or the geometric median of the intersection region.

3. (canceled)

4. The method as claimed in claim 1, wherein the footprint of a LEO satellite is estimated as a convex region, wherein the convex region is estimated as the set of points on a reference surface that have a direct line of sight above a predefined threshold elevation to the LEO satellite.

5. (canceled)

6. The method as claimed in claim 1, wherein determining the location of the terminal by estimating the intersection region of each of the estimated footprints comprises:
defining an error function which is a measure of the error between the estimate of the location obtained from an estimate of the footprint and an estimate of a true location; and
using an optimization method to optimize the error function to obtain an optimized estimate of the true location of the terminal.

7. The method as claimed in claim 1 wherein the intersection region is approximated as a polygon.

8. The method as claimed in claim 7, wherein determining the location comprises determining a centroid of the polygon.

9. The method as claimed in claim 7, further comprising storing the vertices of the polygon, and updating estimates of the vertices of the polygon with each new received transmission from one of the one or more LEO satellites.

10. The method as claimed in claim 7, further comprising updating an estimate of the polygon comprising receiving a new transmission from one of the one or more LEO satellites; estimating a footprint of the new transmission; and calculating the intersection of the new footprint with each line segment defining the polygon and discarding any vertices in an expanded set that lie outside the new footprint.

11. The method as claimed in claim 7, further comprising storing a circular buffer of the n footprints of the n previously received transmissions, and updating an estimate of the polygon each time a new transmission from one of the one or more LEO satellites using the footprints stored in the circular buffer.

12. The method as claimed in claim 1, wherein the method further comprises obtaining an estimate of at least the Doppler frequency for each of the received transmissions and to obtain a refined estimate of the location of the terminal by using a non-linear optimization algorithm configured to use the location of the terminal as an initial location and to refine the estimate of the location by minimizing an error function based on at least the estimated Doppler frequencies.

13. The method as claimed in claim 12, wherein the non-linear optimization algorithm is further configured to use a cost function based on the error function at each location obtained using at least the estimated Doppler frequencies.

14. A method for estimating a location of a transmitter by a satellite communication system comprising a plurality of LEO satellites, the method comprising:
receiving, by one or more LEO satellites, a plurality of transmissions from a transmitter;
obtaining an estimate of a transmission time of each transmission and an ephemeris of each of the plurality of LEO satellites at the transmission time;
estimating at least one footprint for each of the plurality LEO satellites from the plurality of transmissions; and
determining, at a location remote from the transmitter, a location of the transmitter by estimating an intersection region of each of the estimated footprints.

15. The method as claimed in claim 14, further comprising estimating the location within the intersection region, wherein estimating the location comprises estimating a centroid location of the intersection region or the geometric median of the intersection region.

16. (canceled)

17. The method as claimed in claim 16, wherein the footprint of a LEO satellite is estimated as a convex region, wherein the convex region is estimated as the set of points on a reference surface that have a direct line of sight above a predefined threshold elevation to the LEO satellite.

18. (canceled)

19. The method as claimed in claim 14, wherein determining the location of the transmitter by estimating the intersection region of each of the estimated footprints comprises:
defining an error function which is a measure of the error between the estimate of the location obtained from the estimate of the footprint and an estimate of a true location; and
using an optimization method to optimize the error function to obtain an optimized estimate of the true location of the transmitter.

20. The method as claimed in claim 14 wherein the intersection region is approximated as a polygon.

21. The method as claimed in claim 20, wherein determining the location comprises determining a centroid of the polygon.

22. The method as claimed in claim 20, further comprising storing the vertices of the polygon, and updating estimates of the vertices of the polygon with each new received transmission from the transmitter to one of the one or more LEO satellites.

23. The method as claimed in claim 20, further comprising updating an estimate of the polygon comprising receiving a new transmission from the transmitter to one of the one or more LEO satellites; estimating a footprint of the new transmission; and calculating the intersection of the new footprint with each line segment defining the polygon and discarding any vertices in an expanded set that lie outside the new footprint.

24. The method as claimed in claim 20, further comprising storing a circular buffer of the n footprints of the n previously received transmissions, and updating an estimate of the polygon each time a new transmission from the transmitter to one of the one or more LEO satellites using the footprints stored in the circular buffer.

25. The method as claimed in claim 14, further comprising identifying a transmitter by determining one or more signal characteristics of a received transmission, and determining if the signal characteristics match the signal characteristics of a previously received transmission from the transmitter, and if there is a match then using the received transmission to update the estimation of the location of the transmitter.

26. The method as claimed in claim 14, wherein the transmitter is a terminal in the satellite communication system and the method further comprises obtaining an estimate of at least the Doppler frequency for each of the received transmissions and to obtain a refined estimate of the location of the terminal by using a non-linear optimization algorithm configured to use the location of the terminal obtained by the method of claim 14 as an initial location and to refine the estimate of the location by minimizing an error function based on at least the estimated Doppler frequencies.

27. The method as claimed in claim 26, wherein the non-linear optimization algorithm is further configured to use a cost function based on the error function at each location obtained using at least the estimated Doppler frequencies.

28. A terminal for use in a satellite communication system comprising a plurality of LEO satellites, the method comprising:
a receiver for receiving one or more transmissions from one or more of the plurality of LEO satellites; and
at least one processor and at least one memory, wherein the memory is configured to store ephemeris data for the plurality of LEO satellites, and instructions for configuring the at least one processor to;
receive a plurality of transmissions from each of one or more LEO satellites;
obtain an estimate of a current time and ephemeris of each of the one or more LEO satellites;
estimate at least one footprint for each of the plurality LEO satellites from the plurality of transmissions; and
determine a location of the terminal by estimating an intersection region of each of the estimated footprints.

29. A computing apparatus in a LEO satellite or network entity of a satellite communication system comprising a plurality of LEO satellites and a plurality of terminals, the computing apparatus comprising:
at least one processor and at least one memory, wherein the at least one memory is configured to store ephemeris data for the plurality of LEO satellites, and to store instructions for configuring the at least one processor to;
receive a plurality of transmissions from a transmitter;
obtain an estimate of a transmission time of each transmission and an ephemeris of each of the plurality of LEO satellites at the transmission time;
estimate at least one footprint for each of the plurality LEO satellites from the plurality of transmissions; and
determine, at a location remote from the transmitter, a location of the transmitter by estimating an intersection region of each of the estimated footprints.

30. A computer readable medium comprising instructions for configuring one or more processors in a terminal to;
receive a plurality of transmissions from each of one or more LEO satellites;
obtain an estimate of a current time and ephemeris of each of the one or more LEO satellites;
estimate at least one footprint for each of the plurality LEO satellites from the plurality of transmissions; and
determine a location of the terminal by estimating an intersection region of each of the estimated footprints.

31. A computer readable medium comprising instructions for configuring one or more processors to:
receive a plurality of transmissions from a transmitter;
obtain an estimate of a transmission time of each transmission and an ephemeris of each of the plurality of LEO satellites at the transmission time;
estimate at least one footprint for each of the plurality LEO satellites from the plurality of transmissions; and
determine, at a location remote from the transmitter, a location of the transmitter by estimating an intersection region of each of the estimated footprints.
